(19) United States
(12) Patent Application Publication
(10) Pub. No.: US 2020/0017788 A1
(43) Pub. Date: Jan. 16, 2020

(54) Biomass Raw Material Decomposition Device, And Method For Producing Biomass Pellet Fuel

(71) Applicants: Yuki Endo, Kanagawa (JP); Rune Brusietto, Matrand (NO)

(72) Inventors: Yuki Endo, Kanagawa (JP); Rune Brusietto, Matrand (NO)

(73) Assignee: ARBAFLAME AS, Matrand (NO)

(21) Appl. No.: 16/463,930

(22) PCT Filed: Nov. 25, 2016
(86) PCT No.: PCT/JP2016/085062

§ 371 Date: Sep. 18, 2019

(51) Int. Cl. C10L 5/44; B09B 3/00

(52) U.S. Cl. CPC C10L 5/442; B09B 3/0091; C10L 2290/546; C10L 2290/08; C10L 2290/30; C10L 2290/148; C10L 2200/0469; C10L 2290/26; C10L 2290/28

(57) ABSTRACT

A reactor (3) which accommodates a biomass raw material (B1) and heats and decomposes the biomass raw material (B1) using steam (S); an offgas duct (18) through which offgas (G) generated from the biomass raw material (B1) in the reactor (3) flows; a steam generator (4) which combusts the offgas (G) from the offgas duct (18) to generate the steam (S) and supply the steam (S) to the reactor (3); a supply valve (8) which cuts off the reactor (3) from outside air; an offgas valve (19) which adjusts a flow rate of the offgas (G) in the offgas duct (18); a discharge unit (20) which discharges a processed biomass (B2) produced by heating and decomposing the biomass raw material (B1) in the reactor (3); a discharge valve (21) which opens and closes the discharge unit (20); and a control device (7) which controls the offgas valve (19) so that the offgas (G) is able to be discharged to the offgas duct (18) by depressurizing the reactor (3) at a depressurization speed at which no blasting occurs are provided.

### TECHNICAL FIELD

The present invention relates to a biomass raw material decomposition device for decomposing a biomass raw material and a method for producing a biomass pellet fuel by decomposing a biomass raw material.

### BACKGROUND ART

In recent years, from the viewpoint of preventing global warming, biomass has been attracting attention as a substitute for fossil fuels such as coal and heavy oil as a countermeasure for reducing an amount of carbon dioxide emitted and as a countermeasure for the depletion of fossil fuels.

As a biomass, for example, woody plants, grasses, crops, kitchen wastes, and the like are known. By performing thermal decomposition in a reactor using this biomass as a raw material, biomass pellets which eventually become a solid fuel are produced. When biomass pellets are combusted, carbon dioxide is emitted, but unlike fossil fuels, emissions within the framework of the carbon cycle lead to a reduction in the amount of carbon dioxide emitted.

Incidentally, in a case in which biomass pellets are produced from a woody biomass, when a biomass raw material is decomposed in a reactor, an offgas is generated. This offgas contains carbon monoxide, hydrogen, combustible gases such methane, and organic substances such as acetic acid which are generated in a process of decomposing hemicelluloses and the like contained in woody biomass. For this reason, the offgas cannot be released to the atmosphere as it is.

Here, for example, Patent Literature 1 describes a device for processing an offgas from a reactor and effectively using the offgas. In this device, the latent heat of the offgas is recovered using a heat exchanger and non-condensed gases from the heat exchanger are stored in a tank.

### CITATION LIST

### Patent Literature

### Patent Literature 1

PCT International Publication No. WO2014/129910

### SUMMARY OF INVENTION

### Technical Problem

However, in the related art, when biomass pellets are produced from a biomass raw material, a step of performing blasting on a biomass raw material is performed by rapidly depressurizing a reactor. For this reason, in the constitution of the invention disclosed in Patent Literature 1, a flow rate of an offgas is high, the offgas passes through and is discharged from a heat exchanger in a short time, and thus sufficient heat recovery is unlikely to be able to be performed in the heat exchanger. As a result, an amount of offgas to be condensed in the heat exchanger decreases, an amount of water in non-condensed gases which have passed through the heat exchanger increases, and an amount of effluent generated when the non-condensed gases are stored increases. Thus, a failure is likely to occur in a tank which stores the non-condensed gases. Furthermore, organic substances such as acetic acid described above are contained in wastewater (condensed water) generated when an offgas is condensed in the heat exchanger. Therefore, in order to process the wastewater to a level capable of being discharged to sewage, a large-scale wastewater processing device needs to be provided, which causes increase in costs.

The present invention provides a biomass raw material decomposition device and a method for producing a biomass pellet fuel capable of effectively using an offgas while minimizing costs.

### Solution to Problem

A biomass raw material decomposition device according to a first aspect of the present invention includes: an reactor which accommodates a biomass raw material and heats and decomposes the biomass raw material using steam; an offgas flow path through which an offgas generated from the biomass raw material in the reactor flows; a steam generator which combusts the offgas from the offgas flow path to generate steam and supplies the steam to the reactor; a supply valve which cuts off the reactor from outside air; an offgas valve which adjusts a flow rate of the offgas in the offgas flow path; a biomass flow path through which a processed biomass produced by heating and decomposing the biomass raw material in the reactor is discharged; a discharge valve which opens and closes the biomass flow path; and a control device which controls the offgas valve so that the offgas is able to be discharged to the offgas flow path by depressurizing the reactor at a depressurization speed at which no blasting occurs.

According to such a biomass raw material decomposition device, an offgas is combusted in the steam generator to generate steam and the steam is used for decomposing a biomass raw material. For this reason, it is not necessary to provide a heat exchanger or the like to recover energy from the offgas. Thus, water in the offgas does not condense in the heat exchanger and does not generate an effluent. Furthermore, the offgas can be steadily taken slowly outside of a reactor by performing depressurizing so that no blasting (steam explosion) occurs. Therefore, a flow rate of the offgas does not increase rapidly as in the case of blasting in the reactor. For this reason, the offgas can be taken out constantly, the offgas can be supplied to the steam generator continuously, and steam can be constantly generated in the steam generator and transmitted to the reactor. Therefore, energy from the offgas can be efficiently used for decomposing a biomass raw material. Furthermore, since the offgas is taken out constantly, it is not necessary to provide a tank or the like which temporarily stores an offgas. Thus, it is possible to prevent problems such as a tank failure due to the occurrence of an effluent in such a tank.

A biomass raw material decomposition device according to a second aspect of the present invention may further include: a dryer which dries the processed biomass from the biomass flow path in the first aspect to produce dried biomass; a sieving machine which performs sieving on the dried biomass for respective particle sizes to separate the dried biomass into a large-diameter dried biomass having a particle size having a value greater than or equal to a predetermined value and a small-diameter dried biomass having a particle size having a value smaller than a predetermined value; a pulverizer which pulverizes the large-diameter dried biomass to produce a pulverized dried biomass; and a pelletizer which produces a biomass pellet fuel from the small-diameter dried biomass and the pulverized dried biomass.

In this aspect, since no blasting occurs at the time of decomposing a biomass raw material, a proportion of the processed biomass having a large particle size is likely to increase. Here, after drying the processed biomass, the dried biomass is subjected to sieving for respective particle sizes through the sieving machine and the dried biomass having a large diameter is pulverized using the pulverizer. Therefore, the particle sizes of the dried biomass supplied to the pelletizer can be kept small and a biomass pellet fuel can be produced efficiently.

A biomass raw material decomposition device according to a third aspect of the present invention may further include: a compressed gas supply device which supplies a compressed gas provided in the reactor in the first or second aspect.

The compressed gas is supplied into the reactor in this manner so that the processed biomass is extruded and discharged using the pressure of the compressed gas. Thus, the processed biomass can be efficiently discharged from the reactor.

A biomass raw material decomposition device according to a fourth aspect of the present invention may further include: a heat exchanger which exchanges heat with an exhaust gas generated when the offgas is combusted in the steam generator in any one of the first to third aspects to recover heat.

Thus, by further providing the heat exchanger, it is possible to use the recovered thermal energy, for example, when drying the biomass raw material. Therefore, the energy of the offgas can be used more effectively.

A method for producing a biomass pellet fuel according to a fifth aspect of the present invention includes: a decomposition step of mixing a biomass raw material with steam, heating the mixture, and decomposing the mixture in a reactor; an offgas discharging step of depressurizing an offgas generated in the decomposition step at a depressurization speed at which no blasting occurs in the decomposition step and discharging the offgas from the reactor; a steam generation and utilization step of combusting the discharged offgas to generate steam and using the steam in the decomposition step; a processed biomass discharging step of discharging a processed biomass produced in the decomposition step from the reactor; a drying step of drying the processed biomass to produce a dried biomass; and a fuel producing step of subjecting the dried biomass to pelletization to produce a biomass pellet fuel.

According to such a method for producing a biomass pellet fuel, it is not necessary to recover the energy from the offgas using the heat exchanger or the like because steam obtained when the offgas is combusted is used for decomposing the biomass raw material and water in the offgas is not condensed in the heat exchanger or the like, thereby an effluent is not generated. Furthermore, a flow rate of the offgas does not increase rapidly as in case in which blasting occurs in the reactor and steam can be generated constantly and transmitted to the reactor. Thus, the energy from the offgas can be efficiently used. Furthermore, since it is not necessary to use a tank or the like which stores an offgas temporarily, problems such as a tank failure due to the occurrence of an effluent in the tank can be prevented.

A method for producing a biomass pellet fuel according to a sixth aspect of the present invention may further include: a separation step of performing sieving on the dried biomass in the fifth aspect for respective particle sizes to separate the dried biomass into a large-diameter dried biomass having a particle size having a value greater than or equal to a predetermined value and a small-diameter dried biomass having a particle size having a value smaller than a predetermined value; and a pulverizing step of pulverizing the large-diameter dried biomass to produce a pulverized dried biomass, wherein, in the fuel producing step, a biomass pellet fuel may be produced from the small-diameter dried biomass and the pulverized dried biomass.

In this aspect, since no blasting occurs at the time of decomposing a biomass raw material, a proportion of the processed biomass having a large particle size is likely to increase. For this reason, after drying the processed biomass, the dried biomass is subjected to sieving for respective particle sizes and the dried biomass having a large diameter is pulverized so that the particle sizes of the dried biomass can be kept small. Therefore, a biomass pellet fuel can be produced efficiently.

In a method for producing a biomass pellet fuel according to a seventh aspect of the present invention, in the processed biomass discharging step in the fifth or sixth aspect, the processed biomass may be discharged from the reactor by supplying a compressed gas into the reactor.

The compressed gas is supplied into the reactor in this manner so that the processed biomass is extruded and discharged using the pressure of the compressed gas. Thus, the processed biomass can be efficiently discharged from the reactor.

### Advantageous Effects of Invention

According to the biomass raw material decomposition device and the method for producing a biomass pellet fuel, it is possible to effectively use an offgas while minimizing costs.

### BRIEF DESCRIPTION OF DRAWINGS

FIG. 1 is an overall view of a biomass raw material decomposition device according to a first embodiment of the present invention.

FIG. 2 is a graph for describing a state of pressure change in a reactor and a state of flow rate change of offgas when an offgas valve is controlled using a control device in the biomass raw material decomposition device according to the first embodiment of the present invention.

FIG. 3 is a flow diagram for describing a method for producing a biomass pellet fuel using the biomass raw material decomposition device according to the first embodiment of the present invention.

FIG. 4 is an overall view of a biomass raw material decomposition device according to a second embodiment of the present invention.

### DESCRIPTION OF EMBODIMENTS

### First Embodiment

A biomass raw material decomposition device 1 according to a first embodiment of the present invention will be described below.

The biomass raw material decomposition device 1 is, for example, a device which decomposes a biomass raw material B0 such as a woody biomass and finally produces a biomass pellet fuel B.

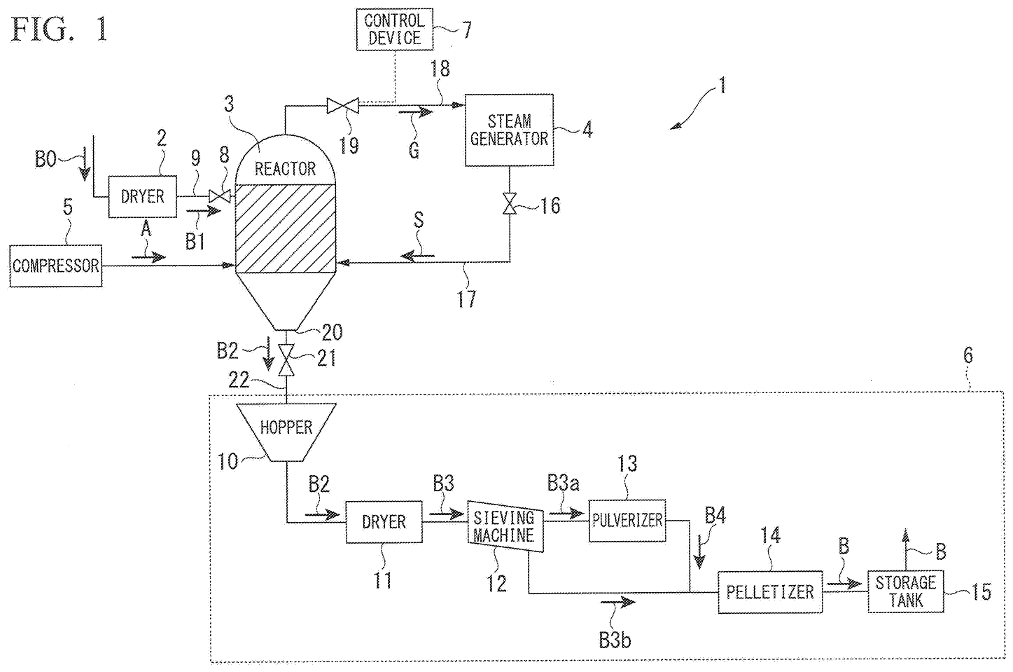

As illustrated in FIG. 1, the biomass raw material decomposition device 1 includes a dryer 2 which dries the biomass raw material B0 to produce a dried biomass raw material B1, a reactor 3 which decomposes the dried biomass raw material B1, a steam generator 4 connected to the reactor 3, a compressor 5, and a pelletizing device 6.

Also, the biomass raw material decomposition device 1 includes an offgas duct 18 (an offgas flow path) which connects the reactor 3 to the steam generator 4, an offgas valve 19 provided in the offgas duct 18, a discharge unit 20 (a biomass flow path) which connects the reactor 3 to the pelletizing device 6, a discharge valve 21 provided in the discharge unit 20, and a control device 7 which controls the offgas valve 19.

The dryer 2 receives the biomass raw material B0 to be introduced therein and dries the biomass raw material B0 using hot air or the like to produce the dried biomass raw material B1.

The reactor 3 is a pressure-resistant container and can accommodate the dried biomass raw material B1 produced using the dryer 2 therein. In this embodiment, the reactor 3 is a so-called batch system. The dried biomass raw material B1 from the dryer 2 is supplied into the reactor 3 through a duct 9.

The duct 9 has a supply valve 8 installed therein. After the dried biomass raw material B1 is supplied to the reactor 3, the reactor 3 is cut off from outside air by closing the supply valve 8.

Also, steam S is introduced into the reactor 3, the dried biomass raw material B1 is heated at a predetermined pressure (for example, about 2 [MPa]), and fibers such as hemicellulose are decomposed, thereby producing a processed biomass B2. At this time, an offgas G which contains a flammable gas, acetic acid, and the like is generated in the reactor 3.

The offgas duct 18 is connected to an upper end of the reactor 3 and the offgas G from the inside of the reactor 3 can flow through the offgas duct 18.

The offgas valve 19 adjusts a flow rate of the offgas G which flows through the offgas duct 18 and enables the reactor 3 to be sealed.

The steam generator 4 is connected to the offgas duct 18 and communicates with the reactor 3 through the offgas duct 18. For example, a bark boiler or the like using bark as a fuel may be used as the steam generator 4. The steam generator 4 generates the steam S by combusting the offgas G. Furthermore, a steam duct 17 is connected to the steam generator 4 and the generated steam S can be supplied to the reactor 3 through the steam duct 17. Moreover, a temperature of the steam supplied to the reactor 3 is about 200 [° C.].

The control device 7 can adjust the flow rate of the offgas G by the offgas valve 19 by performing a control of adjusting a degree of opening of the offgas valve 19.

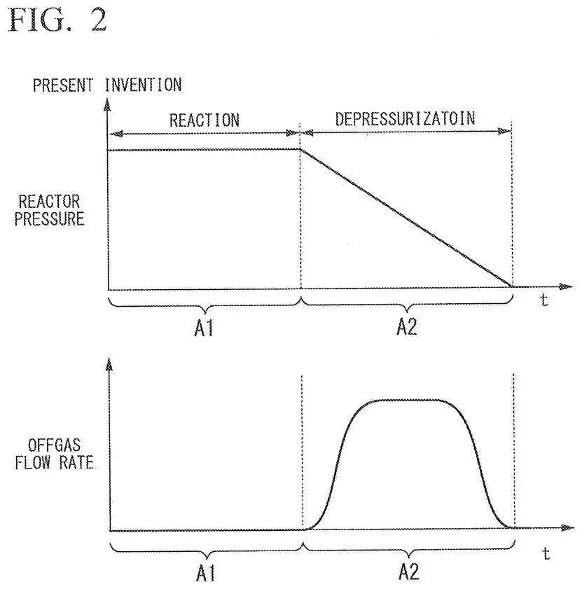

Here, as illustrated in FIG. 2, when the offgas valve 19 is closed (refer to A1 in FIG. 2), the pressure in the reactor 3 is maintained at about 2 [MPa] (20 [bar]). After that, the control device 7 causes the offgas valve 19 to be opened and linearly decreases the pressure inside the reactor 3 at a constantly decreasing rate while monitoring a pressure sensor provided in the reactor 3 (refer to A2 in FIG. 2). Thus, the control device 7 controls the offgas valve 19 so that the offgas G is constantly taken outside of the reactor 3.

That is to say, the control device 7 controls the offgas valve 19 to depressurize the reactor 3 at a depressurization speed at which no blasting occurs so that the offgas G can be discharged. The depressurization speed at which no blasting occurs is, for example, about 0.01 to 0.02 [MPa/sec] (0.1 to 0.2 [bar/sec]).

The discharge unit 20 includes a funnel-shaped portion integrally formed with the reactor 3 at a lower end of the reactor 3 and having a diameter decreasing downward and the duct 22 connected to this portion, thereby the discharge unit is configured to be capable of discharging the processed biomass B2 from the inside of the reactor 3.

Here, the lower end of the reactor 3 may not necessarily be formed in a funnel shape and the entire lower portion of the reactor 3 may be open and a lower portion thereof may be the discharge unit 20.

The discharge valve 21 is provided in the duct 22 of the discharge unit 20 and enables the reactor 3 to be sealed by opening and closing the discharge valve 21.

The compressor 5 compresses air taken in from the outside, generates compressed air A, and supplies the compressed air A into the reactor 3. Here, the compressor 5 may compress an inert gas instead of the compressed air A, generate a compressed gas, and supplies the compressed gas into the reactor 3.

The pelletizing device 6 includes a hopper 10 which receives the processed biomass B2 from the reactor 3, a dryer 11 which dries the processed biomass B2, a sieving machine 12 which performs sieving for respective particle sizes after drying the processed biomass B2, a pulverizer 13 which performs pulverizing after the sieving, and a pelletizer 14 which performs pelletization after the pulverizing. Furthermore, the pelletizing device 6 includes a storage tank 15 which stores the biomass pellet fuel B obtained using the pelletizer 14.

The dryer 11 dries the processed biomass B2 from the hopper 10 using hot air or the like to produce the dried biomass B3.

The sieving machine 12 separates the dried biomass B3 into a large-diameter dried biomass B3a having a particle size having a value greater than or equal to a predetermined value and a small-diameter dried biomass B3b having a particle size having a value smaller than a predetermined value, for example, using a vibrating sieve or the like.

The pulverizer 13 pulverizes only the large-diameter dried biomass B3a sieved through the sieving machine 12 to produce a pulverized dried biomass B4.

The pelletizer 14 performs pelletization by performing compression molding on the pulverized dried biomass B4 obtained through the pulverizing using the pulverizer 13 and the small-diameter dried biomass B3b sieved through the sieving machine 12 to produce the biomass pellet fuel B.

The storage tank 15 stores the biomass pellet fuel B from the pelletizer 14 and the biomass pellet fuel B can be appropriately taken out from the storage tank 15 in accordance with a usage situation.

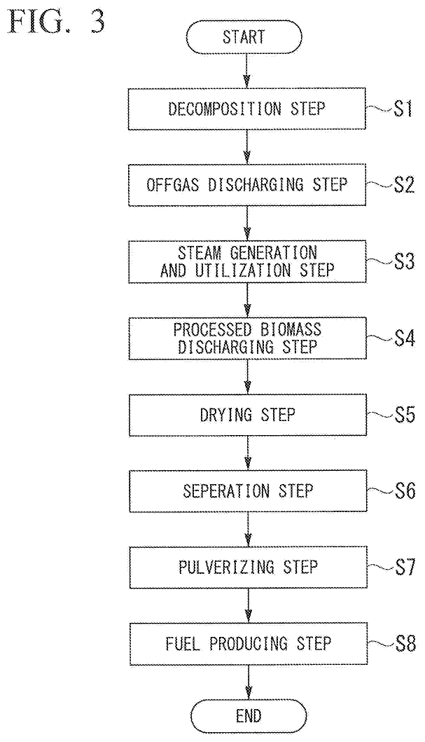

A procedure of a method for producing a biomass pellet fuel B will be described below with reference to FIG. 3.

First, a decomposition step S1 is performed. In the decomposition step S1, a biomass raw material B1 is put into the reactor 3, mixed with steam S, heated, and decomposed, thereby producing a processed biomass B2. With the decomposition, an offgas G is generated. When the decomposition step S1 is performed, the supply valve 8 is closed and the offgas valve 19 and the discharge valve 21 are closed.

After a decomposition reaction in the reactor 3 is completed, an offgas discharging step S2 is performed. That is to say, the offgas valve 19 is opened using the control device 7, and as described above, the reactor 3 is depressurized as illustrated in A2 in FIG. 2 so that no blasting occurs.

And then, a steam generation and utilization step S3 is performed. That is to say, the offgas G is combusted in the steam generator 4 to generate the steam S, the steam S is supplied to the reactor 3, and thus the steam S is utilized as the steam S for performing the decomposition step S1. A steam valve 16 is provided in the steam duct 17 and the steam S is supplied into the reactor 3 at a timing at which the decomposition step S1 is performed. The steam valve 16 may be controlled by the control device 7. Furthermore, when all of the offgas G has been introduced into the steam generator 4, the offgas valve 19 is closed using the control device 7.

Also, a processed biomass discharging step S4 is performed. That is to say, in order to discharge the processed biomass B2 produced in the decomposition step S1 from the reactor 3, the discharge valve 21 is opened. Opening and closing of the discharge valve 21 may be performed using the control device 7 or may be performed manually.

Furthermore, in this embodiment, in the processed biomass discharging step S4, the compressed air A is supplied into the reactor 3 using the compressor 5 so that the processed biomass B2 is extruded from the reactor 3 and discharged. When the compressed air A is supplied, the offgas valve 19 and the discharge valve 21 are closed, and when the pressure inside the reactor 3 reaches a predetermined pressure (for example, about 0.3 to 1 [MPa]), the discharge valve 21 is opened.

After that, a drying step S5 is performed. That is to say, the processed biomass B2 is dried to produce a dried biomass B3. Furthermore, a separation step S6 is performed, and as described above, the dried biomass B3 is separated into a large-diameter dried biomass B3a and a small-diameter dried biomass B3b using the sieving machine 12.

Moreover, a pulverizing step S7 is performed and only the large-diameter dried biomass B3a is pulverized to produce a pulverized dried biomass B4.

Finally, a fuel producing step S8 is performed and the small-diameter dried biomass B3b and the pulverized dried biomass B4 are subjected to pelletization through compression molding to finally produce a biomass pellet fuel B and stored in the storage tank 15.

As described above, in the biomass raw material decomposition device 1 in this embodiment, the offgas G is combusted in the steam generator 4 to produce the steam S and this steam S is used for decomposing the biomass raw material B1. For this reason, it is not necessary to separately provide a heat exchanger or the like to recover energy from the offgas G. Therefore, it becomes possible to prevent water in the offgas G from condensing to generate effluent in a heat exchanger or the like.

Also, when the offgas G is depressurized so that no blasting (steam explosion) occurs, the offgas G can be steadily taken out slowly from the reactor 3. Accordingly, as in the case in which blasting occurs in the reactor 3, a flow rate of the offgas G may not increase rapidly in some cases. For this reason, the offgas G can be taken out constantly, the offgas G can be continuously supplied to the steam generator 4, the steam S can be regularly produced in the steam generator 4, and the steam S can be transmitted to the reactor 3.

Thus, energy from the offgas G can be efficiently used. Furthermore, since the offgas G is constantly extracted, it is not necessary to separately provide a tank or the like for temporarily storing the offgas G. For this reason, problems such as tank failure due to the occurrence of an effluent in the tank can be prevented.

Therefore, in the biomass raw material decomposition device 1 in this embodiment, it is possible to efficiently use the offgas G while minimizing costs.

Furthermore, since no blasting occurs at the time of decomposing the biomass raw material B1 in the above-mentioned embodiment, a proportion of the processed biomass B2 having a large particle size is likely to increase. In this respect, after drying the processed biomass B2, the dried biomass B3 is subjected to sieving for respective particle sizes through the sieving machine 12 and the dried biomass B3 having a large diameter is pulverized using the pulverizer 13. Therefore, the particle sizes of the dried biomass 13 supplied to the pelletizer 14 can be kept small and a biomass pellet fuel B can be produced efficiently.

Also, in the processed biomass discharging step S4, by supplying compressed air A into the reactor 3, the processed biomass B2 is extruded outside of the reactor 3 due to the pressure of the compressed air A and can be efficiently discharged from the reactor 3 to the hopper 10.

Furthermore, the steam generator 4 performs mixing of the offgas G containing water or the like and performs combusting unlike a case in which only bark is combusted. Thus, it is possible to produce the steam S while preventing a furnace of the steam generator 4 from becoming excessively hot and being damaged.

### Second Embodiment

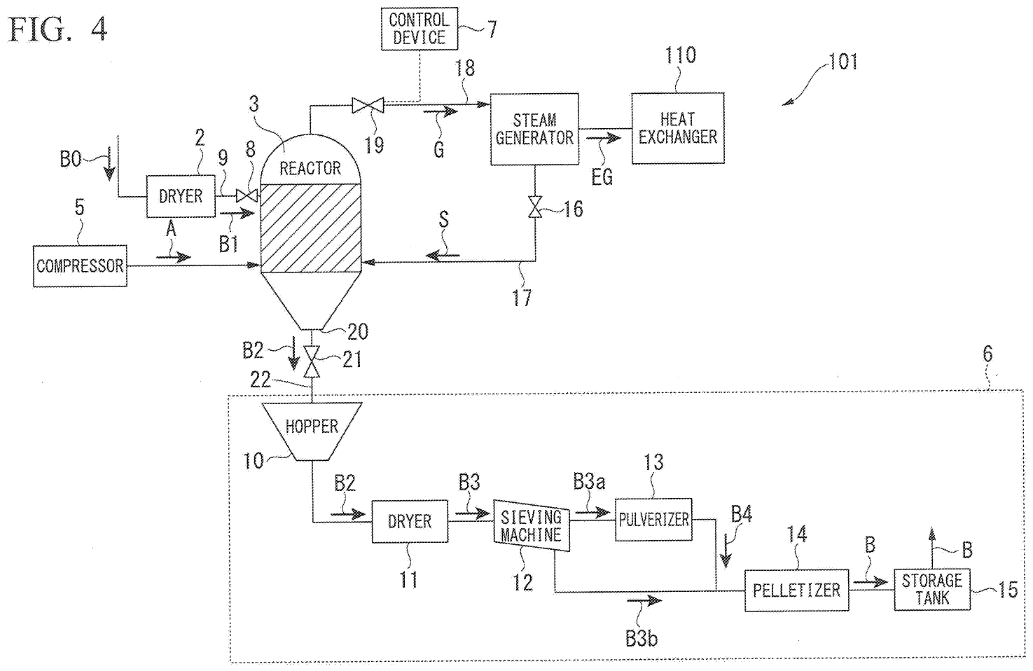

A second embodiment of the present invention will be described below with reference to FIG. 4.

Constituent elements that are the same as in the first embodiment will be denoted with the same reference numerals and detailed description thereof will be omitted.

A biomass raw material decomposition device 101 in this embodiment is different from the first embodiment in that the biomass raw material decomposition device 101 in this embodiment further includes a heat exchanger 110.

The heat exchanger 110 is provided on a downstream side of a steam generator 4, receives an exhaust gas EG generated when the offgas G is combusted using the steam S introduced therein, and recovers heat from this exhaust gas EG. Hot air is generated, for example, by increasing a temperature of air using the recovered thermal energy.

In the biomass raw material decomposition device 101 in this embodiment, by further providing the heat exchanger 110, the recovered thermal energy can be used, for example, at the time of drying biomass raw material B0 and processed biomass B2. Therefore, the energy of the offgas G can be used more effectively.

Although the embodiments of the present invention have been described in detail above with reference to the drawings, each constitution in each embodiment and a combination thereof are one example and additions, omissions, substitutions, and other modifications of the constitution are possible without departing from the scope of the present invention. Furthermore, the present invention is not limited by the embodiment and is limited by the scope of the claims.

For example, in the method for producing a biomass pellet fuel B, the separation step S6 and the pulverizing step S7 may not necessarily be included.

Also, the compressor 5 may not necessarily be provided. That is to say, in the processed biomass discharging step S4, the processed biomass B2 may be discharged from the reactor 3 to the hopper 10 using a force of gravity without supplying compressed air A into the reactor 3.

Furthermore, when the reactor 3 is depressurized at a depressurization speed at which no blasting occurs, the offgas valve 19 may be controlled manually instead of the control device 7.

Moreover, an amount of steam S to be generated may be adjusted by appropriately putting bark in accordance with an amount of offgas G to be supplied in the steam generator 4.

### INDUSTRIAL APPLICABILITY

According to the above-described biomass raw material decomposition device and method for producing a biomass pellet fuel, it is possible to effectively use an offgas while minimizing costs.

### REFERENCE SIGNS LIST

1, 101 Biomass raw material decomposition device
2 Dryer
3 Reactor
4 Steam generator
5 Compressor
6 Pelletizing device
7 Control device
8 Supply valve
9 Duct
10 Hopper
11 Dryer
12 Sieving machine
13 Pulverizer
14 Pelletizer
15 Storage tank
16 Steam valve
17 Steam duct
18 Offgas duct (offgas flow path)
19 Offgas valve
20 Discharge unit (biomass flow path)
21 Discharge valve
22 Duct (biomass flow path)
B Biomass pellet fuel
B0 Biomass raw material
B1 Dried biomass raw material
G Offgas
B2 Processed biomass
B3 Dried biomass
B3a Large-diameter dried biomass
B3b Small-diameter dried biomass
B4 Pulverized dried biomass
A Compressed air
W Steam
S1 Decomposition step
S2 Offgas discharging step
S3 Steam generation and utilization step
S4 Processed biomass discharging step
S5 Drying step
S6 Separation step
S7 Pulverizing step
S8 Fuel producing step
110 Heat exchanger
EG Exhaust gas

1. A biomass raw material decomposition device, comprising:
a reactor which accommodates a biomass raw material and heats and decomposes the biomass raw material using steam;
an offgas flow path through which an offgas generated from the biomass raw material in the reactor flows;
a steam generator which combusts the offgas from the offgas flow path to generate steam and supplies the steam to the reactor;
a supply valve which cuts off the reactor from outside air;
an offgas valve which adjusts a flow rate of the offgas in the offgas flow path;
a biomass flow path through which a processed biomass produced by heating and decomposing the biomass raw material in the reactor is discharged;
a discharge valve which opens and closes the biomass flow path; and
a control device which controls the offgas valve so that the offgas is capable of being discharged to the offgas flow path by depressurizing the reactor at a depressurization speed at which no blasting occurs.

2. The biomass raw material decomposition device according to claim 1, further comprising:
a dryer which dries the processed biomass from the biomass flow path to produce dried biomass;
a sieving machine which performs sieving on the dried biomass for respective particle sizes to separate the dried biomass into a large-diameter dried biomass having a particle size having a value greater than or equal to a predetermined value and a small-diameter dried biomass having a particle size having a value smaller than a predetermined value;
a pulverizer which pulverizes the large-diameter dried biomass to produce a pulverized dried biomass; and
a pelletizer which produces a biomass pellet fuel from the small-diameter dried biomass and the pulverized dried biomass.

3. The biomass raw material decomposition device according to claim 1, further comprising:
a compressed gas supply device which supplies a compressed gas provided in the reactor.

4. The biomass raw material decomposition device according to claim 1, further comprising:
a heat exchanger which exchanges heat with an exhaust gas generated when the offgas is combusted in the steam generator to recover heat.

5. A method for producing a biomass pellet fuel, comprising:
a decomposition step of mixing a biomass raw material with steam, heating the mixture, and decomposing the mixture in a reactor;
an offgas discharging step of depressurizing an offgas generated in the decomposition step at a depressurization speed at which no blasting occurs in the decomposition step and discharging the offgas from the reactor;
a steam generation and utilization step of combusting the discharged offgas to generate steam and using the steam in the decomposition step;
a processed biomass discharging step of discharging a processed biomass produced in the decomposition step from the reactor;
a drying step of drying the processed biomass to produce a dried biomass; and
a fuel producing step of subjecting the dried biomass to pelletization to produce a biomass pellet fuel.

6. The method for producing a biomass pellet fuel according to claim 5, further comprising:
a separation step of performing sieving on the dried biomass for respective particle sizes to separate the dried biomass into a large-diameter dried biomass having a particle size having a value greater than or equal to a predetermined value and a small-diameter dried biomass having a particle size having a value smaller than a predetermined value; and
a pulverizing step of pulverizing the large-diameter dried biomass to produce a pulverized dried biomass,
wherein, in the fuel producing step, a biomass pellet fuel is produced from the small-diameter dried biomass and the pulverized dried biomass.

7. The method for producing a biomass pellet fuel according to claim 5, wherein, in the processed biomass discharging step, the processed biomass is discharged from the reactor by supplying a compressed gas into the reactor.
